(19) United States
(12) Patent Application Publication
(10) Pub. No.: US 2010/0316309 A1
(43) Pub. Date: Dec. 16, 2010

(54) CONSUMER BAGS AND PROCESSES OF MANUFACTURE, DISPENSERS, AND DISPENSING SYSTEMS FOR CONSUMER BAGS

(75) Inventor: Harry B. Wilfong, Hartsville, SC (US)

Correspondence Address: Nelson Mullins Riley & Scarborough LLP;IP Department, 100 North Tryon Street, 42nd Floor, Charlotte, NC, 28202-4000, US

(73) Assignee: Hilex Poly Co. LLC, Hartsville, SC (US)

(21) Appl. No.: 12/813,695

(22) Filed: Jun. 11, 2010

Related U.S. Application Data
(60) Provisional application No. 61/186,696, filed on Jun. 12, 2009.

(51) Int. Cl. B65D 30/00; B31B 27/00; B31B 27/14; B65H 35/10

(52) U.S. Cl. 383/37; 206/390; 493/227; 493/230; 225/16; 225/46; 225/91

(57) ABSTRACT

A process for manufacturing bags and the resulting bag are disclosed. The bags may be continuously and detachably connected, and continuously and detachably connected bags may be wound onto a roll. In addition, a dispenser is disclosed for storing and dispensing bags. Also disclosed is an apparatus for use in dispensing plastic bags. A dispensing system is disclosed for continuously and detachably connected series of bags and in which the removal of a bag results in the subsequent bag in the series being at least partially opened.

### CROSS-REFERENCE TO RELATED APPLICATIONS

The present application claims priority to U.S. Provisional Patent Application Ser. No. 61/186,696, filed on Jun. 12, 2009 and incorporated herein by reference in its entirety.

### FIELD OF INVENTION

The present invention relates to the manufacture and design of consumer bags and dispensers used with those bags.

### BACKGROUND

Consumers and shoppers purchasing items, such as produce, often use bags to collect and carry those items. In many stores, such bags are stored and dispensed from dispensers.

### SUMMARY OF THE INVENTION

The present invention provides a novel and useful bag, a series of continuously and detachably connected bags, and a process and system for manufacturing such bags. In addition, the present invention includes a novel dispenser for storing and dispensing bags. Finally, the present invention includes a novel dispensing system in which the removal of a bag from a series of continuously and detachably connected bags results in the subsequent bag in the series being at least partially opened when dispensed.

The present invention includes a dispenser for serially dispensing bags from a wound roll of bags. In one embodiment, the dispenser comprises a frame, a support member attached to the frame and configured to fit within and at least partially support the wound roll of bags, a biased arm attached to the frame and configured to fit within the core of said wound roll of bags and exert a biased pressure against the core, and a separation member attached to the frame.

The present invention also includes an assembly for n assembly for use in serially dispensing bags from a wound roll of bags having a core, wherein said assembly comprises a support member configured to fit within the core of said wound roll of bags and to at least partially support said wound roll of bags, a biased arm attached to said support member and configured to fit within the core of said wound roll of bags and exert a biased pressure against said core, an extension member joined with said support member, and a separation member on said extension member.

The present invention also includes a wound roll of continuous and detachably connected bags. In one embodiment, each bag of the roll comprises a mouth end, a bottom end, two or more opposing faces, two or more lateral sides, an arrangement of six plies, a perforation line detachably connecting the bags, a gusset on each lateral side, and a center slit that does not overlap the gusset. In addition, the bags may be wound in a direction such that a mouth end of each bag is dispensed before a bottom end of the bag.

The present invention further includes a method for manufacturing bags. In one embodiment, the method comprises the steps of forming a gusset in the plastic tubing; perforating the plastic tubing to render adjacent individual bags continuously and detachably connected; cutting the plastic tubing to form a mouth end for an individual bag; cutting a center slit in the plastic tubing; forming a heat seal in a roll of plastic tubing to form the bottom end of an individual bag; C-folding the plastic tubing at or within the inner gusset point to create six plies; and winding the bags on a core.

The present invention also includes a dispensing system for use with a series of continuously and detachably separable bags wherein the removal of a bag at least partially opens the subsequent bag in the series. In one embodiment, the dispensing system comprises a dispenser having a separation member. In addition, the series of continuously and detachably separable bags may further comprise a mouth end, a bottom end, two or more opposing faces, two or more lateral sides, six plies, a perforation line detachably connecting the bags, a gusset on each lateral side, and a center slit that does not overlap the gusset. In addition, the series of continuously and detachably separable bags may be wound into a roll such that the mouth end of each bag is dispensed before the bottom end of the bag.

The present invention may be better understood by reference to the description and figures that follow. It is to be understood that the invention is not limited in its application to the specific details as set forth in the following description and figures. The invention is capable of other embodiments and of being practiced or carried out in various ways.

### BRIEF DESCRIPTION OF THE DRAWINGS

These and other features, aspects, and advantages of the present invention are better understood when the following Detailed Description is read with reference to the accompanying drawings, wherein:

FIG. 1 shows a perspective view of a manufacturing process of the present invention.

FIG. 2 shows a side view of the process shown in FIG. 1.

FIG. 3 shows a partially cut away view of the process shown in FIG. 1.

FIG. 4 is a perspective view of a “t-shirt” bag manufactured according to the present invention.

FIG. 5 is a top view of the bag of FIG. 4 taken along the line 5-5.

FIG. 6 shows an alternative embodiment of a manufacturing process of the present invention

FIG. 7 is representative of an embodiment of a series of continually and detached gusseted bags.

FIG. 8 shows a wound roll of continually and detached gusseted bags.

FIG. 9 is a view of FIG. 8 taken along the line 8-8.

FIG. 10 shows a representative view of a gusseted bag.

FIG. 11A shows the gusseted bag of FIG. 10 after being longitudinally C-folded at the inner gusset points.

FIG. 11B shows the gusseted bag of FIG. 10 after being longitudinally C-folded within the interior of the inner gusset points.

FIG. 12 is a representation of the plies of a gusseted bag that has been C-folded to form a six-ply bag.

FIG. 13 shows an embodiment of the dispenser of the present invention.

FIG. 14 shows the dispenser of FIG. 13 with rolls of bags loaded.

FIG. 15 shows the torsion along a biased arm in the dispenser depicted in FIG. 13, with portions in shadow for clarity.

FIG. 16 shows an alternative embodiment of the dispenser of the present invention.

FIG. 17 shows the dispenser of FIG. 16 with rolls of bags loaded.

FIG. 18 shows an alternative embodiment of the dispenser of the present invention.

FIG. 19 shows an alternative embodiment of the dispenser of the present invention.

FIG. 20 shows another alternative embodiment of the dispenser of the present invention.

FIG. 21 shows the tear pattern for the perforation line of a self-opening bag of the present invention.

FIG. 22 shows the tear pattern for self-opening, detachably and continuously connected bags of the present invention.

FIG. 23 shows the tear pattern for a hag of FIG. 22 in isolation.

### DETAILED DESCRIPTION OF EXEMPLARY EMBODIMENTS

Embodiments of the present invention comprise processes and systems for manufacturing bags. Other embodiments of the present invention include bags, series of continuously and detachably separable bags, and wound rolls of continuously and detachably separable bags. Yet other embodiments of the present invention include bag dispensers. Still other embodiments of the present invention include dispensing systems for the self-opening of bags when dispensed from a series of continuously and detachably separable bags.

Use of reference characters with the same ending numerals to indicate structure in the present specification and drawings, without a specific discussion of such structure, is intended to represent the same or analogous structure in different embodiments. For example, and as further seen herein, the structures indicated by reference characters 104, 204, and 304 all indicate the frame of a bag dispenser in various embodiments of the present invention.

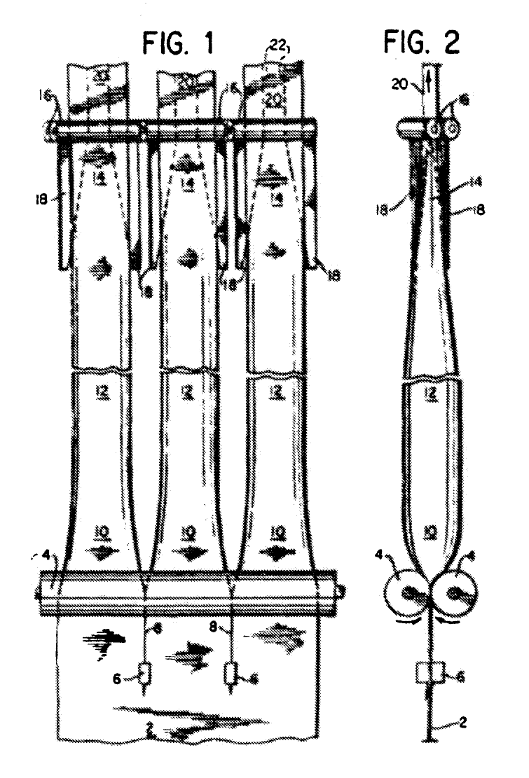

Referring to the Figures, and particularly referring to FIG. 1, a perspective view of the manufacturing process of the present invention is shown. One process exemplified herein shows the making of self-opening bags in an alignment that produces three bags at a time. It is to be appreciated that additional arrangements could be employed to make fewer or more bags at a time.

As further shown in FIG. 2, a continuous, flattened tube 2 of thermoplastic film is drawn through a set of entry rollers 4. The thermoplastic film may be made from polyethylene. Specifically, linear, low density polyethylene (LLDPE), low density polyethylene (LDPE), high density polyethylene (HDPE), and high molecular weight, high density polyethylene (HMW-HDPE) are examples, but other thermoplastic materials, including copolymers, can be used.

Before entry of flattened tube 2 between entry rollers 4, tube 2 is longitudinally slit and sealed into three separate tubes of equal diameter by hot knives 6. Each hot knife 6 slices the two walls of tube 2 and then immediately seals the resulting two edges to form two separate seals from each hot knife 6.

Upon passing through entry rollers 4, three separate tubes 10 are individually inflated with gas to form cylinders 12. The gas can be nitrogen, argon or other inert gas, air or other gas. The individual cylinders 12 formed from tubes 10 are drawn into and through three separate sets of exit rollers 16. The seals created by entry rollers 4 and exit rollers 16 maintain the gas trapped in each cylinder 12. Thus, individual cylinders 12 need be inflated with gas only at the beginning of a production run. Once inflated, the cylinders can be maintained without further introduction of gas (unless a defect in the cylinder causes the gas to escape).

Immediately before each cylinder 12 enters its respective set of exit rollers 16, the cylinder is distorted by gusseting boards 18. A pair of gusseting boards 18 is provided for each cylinder. The pair of boards is oriented such that external pressure may be applied to opposite sides of the circumference of each cylinder 12. The pair of gusseting boards 18 forms an open wedge such that the cylinder 12 being drawn between the boards 18 is gradually distorted until the maximum desired distortion is obtained. Exit rollers 16 are positioned immediately after gusseting boards 18 to collapse the distorted cylinders 14. Gusseted tubes 20 emerge from each pair of exit rollers 16. The central fold 22 of each gusseted tube 20 corresponds to the maximum point of distortion of gusseting boards 18.

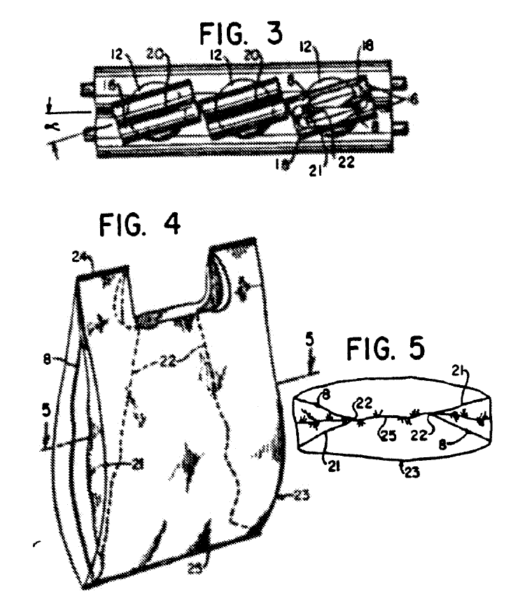

Each pair of gusseting boards 18 lies in a plane oriented parallel to the longitudinal axis of exit rollers 16. Each set of exit rollers 16 is skewed with respect to the longitudinal axis of entry rollers 4, as shown in FIG. 3, which is a cut-away view of the apparatus shown in FIG. 1. The angle between the entry rollers and the exit rollers is designated angle α in FIG. 3. By orienting the gusseting boards 18 and exit rollers 16 at angle α to the longitudinal axis of entry rollers 4, the central fold 22 of the gusset 21 is created at a point other than at slit seal 8.

The exact position of slit seal 8 relative to central fold 22 can be varied by changing angle α. For example, at angle α of 0 degrees, slit seals 8 will be positioned at central fold 22, which is the orientation that has been previously used in other devices. As angle α is increased, slit seal 8 will be positioned farther from central fold 22. Angle α can be further increased until a maximum angle is reached, beyond which slit seals will fall outside of gusset 21.

The range of angle α depends upon the circumference of cylinder 12, and the distance between central fold 22 of gusset 21 and external fold 28. In turn, the circumference (C) of cylinder 12 is determined by the desired width (W) of bag 23 and the depth (D) of each gusset 21. The circumference is thus defined as twice the width (W) plus four times the depth (D); or C=2W+4D. Angle α is then defined as:

$$α = \frac{360 ( D )}{2 ( W ) + 4 ( D )}$$

For example, a bag having a desired width of 10 inches and a desired gusset width of 2 inches could be constructed according to the present invention using an angle α defined as:

$$α = \frac{360 ° ( 2 )}{2 ( 10 ) + 4 ( 2 )} = \frac{720}{28} = 25.7 °$$

Thus α can be set at 0°<α<25.7° in order to have slit seal 8 fall between central fold 22 and external fold 28.

Gusseted tubes 20 emerging from exit rollers 16 are then heat sealed and cut in the transverse direction to form individual bags having heat seals at top 24 and bottom 25 of bag 23. Referring to FIG. 4, a handle 26 is created by die cutting a portion from the bag 23.

The cross-sectional view of bag 23 shown in FIG. 5 indicates the position of two slit seals 8 along the side of the gusset wall. Slit seals 8 can be oriented at any point along the walls of gusset 21 except for central fold 22 or external folds 28. Positioning slit seals along the gusset walls ensures that slit seals 8 will extend from top seal 24 to bottom seal 25 of bag 23. This configuration will place a minimum of stress on slit seal 8 and a stronger plastic bag is thus obtained. Alternatively, the slit seals can be positioned such that they are located within the area between the gussets of a gusseted bag. In such an embodiment, the slit seals can be overlapping or staggered.

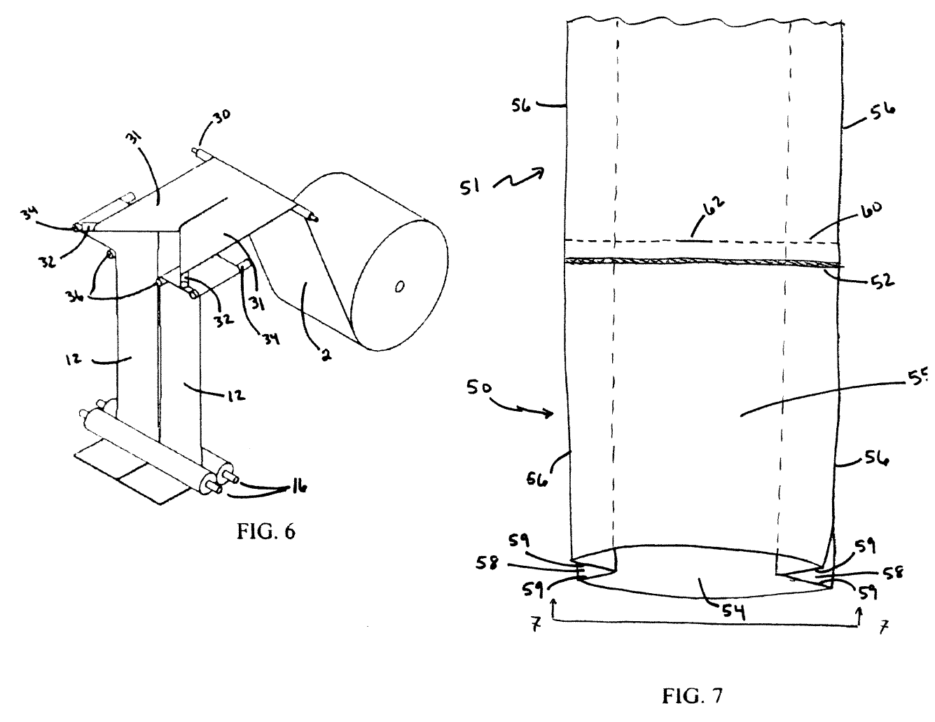

FIG. 6 shows another embodiment of a process of the present invention. In this depicted embodiment, a continuous, flattened tube 2 is passed over a roller 30. The flattened tube 2 is longitudinally slit and sealed into two separate flat tubes 31 using a hot knife (not shown). As a result, a slit seal is formed on the inside portion of each flat tube 31 at the location where the cutting and sealing occurred. Each flat tube 31 then passes over turnbars 32, 34, and 36. After passing over turnbar 36, the tubing is inflated with gas to form cylinder 12, such as in the manner described above. The cylinder 12 then passes through exit rollers 16, which are depicted as skewed 90° from turnbar 36. Similar to the angle between the entry rollers 4 and the exit rollers 16 in FIG. 1, this angle variation results in the slit seal being repositioned. In the depicted process, the slit seal is repositioned to the center of the bottom face of the flattened tube 31 as it leaves exit rollers 16. In contrast to FIG. 1, the manufacturing assembly shown in FIG. 6 does not lie in the same plane. In addition, it will be apparent to one of ordinary skill in the art that gusseting boards, such as the gusseting boards 18 shown in FIG. 1, can be added to the process and manufacturing assembly depicted in FIG. 6. Likewise, one of ordinary skill in the art will appreciate that the present invention includes embodiments of the manufacturing assembly and process in which quantities of gusseted tubes 20 or flat tubes 31 are created from flattened tube 2 other than the quantities shown in FIGS. 1 and 6.

In another embodiment of the present invention, the gusseted tubes 20 emerging from exit rollers 16 are heat sealed and perforated and wound onto a roll resulting in a continuous roll of detachably connected bags. For instance, FIG. 7 depicts an embodiment of the continuous and detachably connected bags 50 and 51 resulting from this process. As shown in FIG. 7, a bag 50 has a bottom end 52 that is formed by a heat seal, a mouth end 54, two opposing faces 55, and two lateral sides 56. As shown, the bottom end 52 and the mouth end 54 are on opposing longitudinal ends. In the depicted embodiment, the bag 50 is shown with gussets 58 on each side 56, which are not shown for bag 51.

Bag 50 is continuously and detachably connected from an adjoining bag 51 by a perforation line 60. The perforation line 60 generally comprises alternating cuts, in which the tubing forming the bag is severed, and the uncut portions between the cuts in the perforation line are called ties. In one embodiment, perforation line 60 comprises a pattern in which the tie distance is no more than one half of the adjacent cut distance.

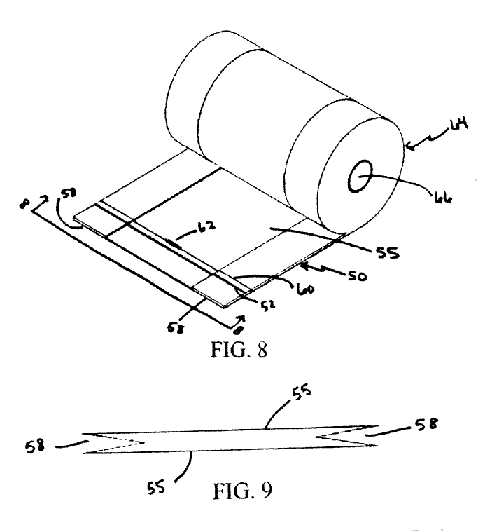

FIG. 7 also depicts a center slit 62 in the perforation line 60. It will be understood by one of ordinary skill in the art that center slit 62 alternatively can be located on either longitudinal side of perforation line 60, such as closer to mouth end 54 or bottom end 52. In another embodiment, the center slit 62 can additionally or alternatively be located closer to one of the opposing lateral sides 56. Continuous and detachably connected bags 50 can be wound onto a roll having a core 64 to form a wound roll of bags 64, as shown in FIG. 8. FIG. 9 shows a cross-sectional view of bag 50 along line 8-8 of FIG. 8, wherein the opposing faces 55 and gussets 58 are shown.

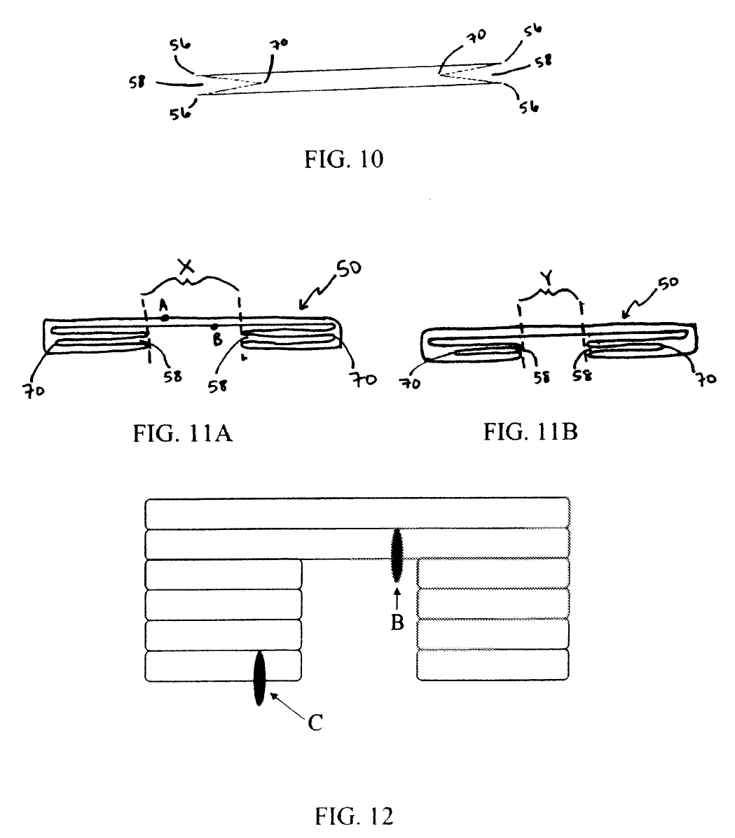

In addition, in another embodiment of the present invention, the bags can be folded before being wound onto a roll, such as by C-folding as shown in FIGS. 10, 11A, and 11B. In the embodiment shown in FIG. 10, which is a cross-sectional view along line 7-7 of bag 50 in FIG. 7, a lengthwise C-fold is made along the bag 50 at the inner gusset point 70 to yield the six-ply bag shown in FIG. 11A. In another embodiment, as shown with reference to FIG. 11B, the bag 50 is longitudinally C-folded within the interior of each inner gusset point 70, i.e., a lengthwise fold at a point between each inner gusset point 70 and the center of face 55. The general process and apparatus for C-folding, such as the process disclosed in U.S. Pat. No. 4,607,830, which is incorporated herein by reference in its entirety, is known to one of ordinary skill in the art. In addition, the folding can be done before or after the heat sealing and perforation steps.

In one embodiment, the gussets of the gusseted tubing are no more than 25% of the width of the gusseted tubing before folding. For instance, as shown in FIG. 10, each gusset 58 (between lateral side 56 and inner gusset point 70) is no more than 25% of the width of the entire gusseted bag 50 (from lateral side 56 to opposing lateral side 56). As a result, the gussets 58 do no overlap after folding at the inner gusset points 70, as shown in FIG. 11A. In addition, if the gussets 58 are less than 25% of the width of the gusseted tubing before folding, as shown in FIG. 10, a two-ply region can be formed, as shown in the areas X and Y between the dashed lines in FIGS. 11A and 11B, between the gussets 58 after C-folding at or within the interior of the inner gusset points 70. In one embodiment, a center slit 62 is located in this two-ply region. In other embodiments, the gussets 58 after C-folding may combine to equal the width of the folded bag, such that the gussets 58 equal the width of the bag after folding, i.e., in the C-folded bag, the gussets reach each other but do not touch. In yet other embodiments, the gussets 58 may overlap after folding. In addition, it will be apparent to one of ordinary skill in the art that other types of folding are encompassed by the present invention, such as W-folding. By way of example, the bag 50 shown in FIG. 11A can be W-folded by creating an additional fold in the center of the two-ply region.

In addition, the embodiments shown in FIG. 11A or 11B may comprise one or more slit seals resulting from the cutting and sealing operation described above. Due to the cutting and sealing operation, the slit seals likely have a greater thickness than a single ply of bag 50 and thus form a slightly raised portion along the length of the tubing and, ultimately, the bag. Without using the above-described process of the present invention to position the slit seal, the slit seal would be present at one or both inner gusset points 70 and a high point could result when the bags are wound on a roll due to the increased thickness at the point of the slit seal. However, the slit seal may be positioned in a region of the folded bag having the least number of plies to avoid such a high spot in the wound roll of bags. By way of example, by use of the process previously described herein, any slit seals in the folded bag shown in FIG. 11 could be positioned so as to be located in the two-ply region of the bag, such as at reference point A and/or reference point B in FIG. 11. At these positions, the increased thickness at the point of the slit seals remains lower in thickness than the six-ply regions of the bag when wound onto a roll. Alternatively, if the slit seal were placed in the six-ply region, the increased thickness of the slit seal may create a “high spot” in the roll of bags.

The foregoing is further represented in FIG. 12, which shows a representational schematic of the folded bag 50 in FIG. 11 to elaborate each ply 72. By way of example, each ply 72 may have a thickness of 0.0005 inches. Thus, the two-ply region has a thickness of 0.001 inches, and the six-ply region has a thickness of 0.003 inches. The slit seal may have a thickness of 0.001 inches. Thus, a slit seal located in the six-ply region, such as at reference point C, would increase the thickness at that point to 0.004 inches, which would be the thickest point on the roll and thereby create a high spot. By contrast, a two-ply region of the bag would have a thickness of 0.001 inches, and a slit seal in this region as shown by reference point B would increase a point in this region to 0.002 inches, which is still less thick than the adjacent six-ply region. Accordingly, because the thickness of the slit seal in the two-ply region creates a point with less thickness than the adjacent six-ply regions, no high spot is created in the wound roll, e.g., the thickest point in the two-ply region remains less thick than the thickness of the six-ply region. It will be apparent to one of ordinary skill in the art that the foregoing, including the measurements, is exemplary in nature and that the placement of the slit seal may vary in different embodiments of the present invention.

Other embodiments of the present invention include processes and products in which the slit seal is not moved from the central fold of the gusset as well as products and processes in which no slit seal is formed, such as in a single-lane production process. In addition, the present invention includes bags with or without gussets and the accompanying processes.

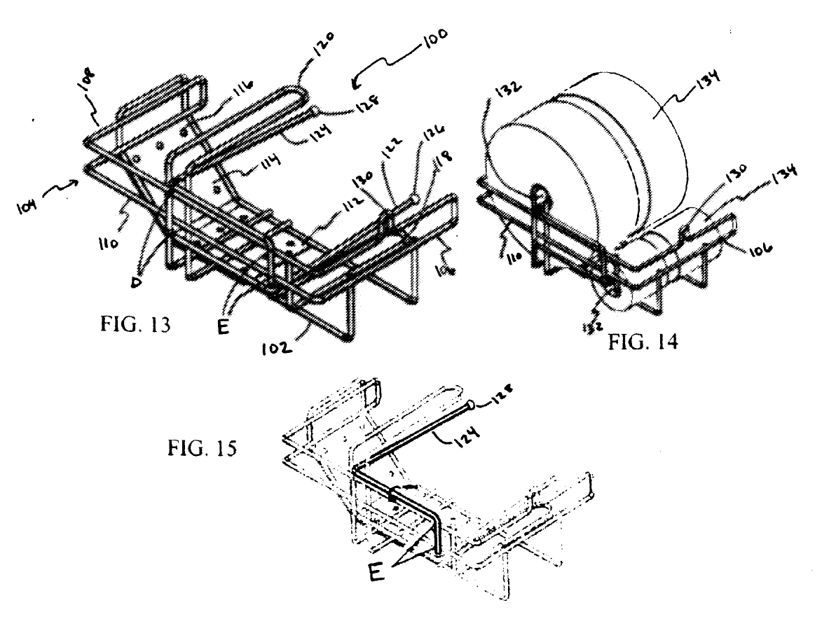

The present invention also includes dispensers for storing and dispensing rolls of bags. The roll of bags for use with the present dispenser can be of any type known in the art. FIG. 13 depicts an embodiment of a dispenser of the present invention. As illustrated, a dispenser 100 is constructed of a wire frame, such as stainless steel wire. As shown, dispenser 100 has a base member 102 and a frame member 104, wherein frame member 104 has a first end 106, a second end 108, and a side member 110. Dispenser 100 also comprises a first mounting plate 112, depicted in the figure as attached to the base member 102, and a second mounting plate 114, depicted in the figure as attached between base member 102 and the second end 108. First mounting plate 112 and second mounting plate 114 each have mounting holes 116, which can vary in number, size, and location in accordance with the present invention. The first mounting plate 112 and second mounting plate 114 permit dispenser 100 to be attached to a post, wall, stand, counter, shelf, or other suitable supporting beam or surface by use of conventional fasteners such as nails, screws, or the like. Alternatively, base member 102 can rest on a surface, such as a counter top, shelf, or other surface, without any fasteners.

Dispenser 100 also has a first support member and a second support member, each shown in the pictured embodiment as U-shaped wires 118 and 120 that are attached to side member 110. In the depicted embodiment, U-shaped wire 120 is located above and behind U-shaped wire 118. As depicted in FIG. 13, the first support member. U-shaped wire 118, is attached to the side member 110 and the base member 102, and the second support member. U-shaped wire 120, is attached to the side member 110. The attachment can be made by any conventional means, such as welding or bonding, or the first support member and/or second support member can be integral to the frame member 104.

As shown in FIG. 13, dispenser 100 also comprises a first biased arm 122, shown as attached to the side member 110 at attachment points D, and a second biased arm 124, shown as attached to the side member 110 at attachment points E. The first biased arm 122 may be biased outwardly away from the first support member 118, and the second biased 124 arm may be biased outwardly away from the second support member 120. In addition, first biased arm 122 is shown comprising a retainer end 126 at its distal end and second biased arm 124 is shown comprising a retainer end 128 at its distal end. As depicted, retainer ends 126 and 128 are integral to the first biased arm 122 and second biased arm 124, respectively, but in other embodiments a retainer end can be of varying shapes and materials that may be integral or nonintegral with a biased arm or made of material different from the material from which dispenser 100 is made.

Dispenser 100 also includes a separation member, which is shown in FIG. 13 as a tongue 130 that is integral to the first end 106. The present invention includes other embodiments of the separation member, such as tongues of different shapes and plates of varying geometry. For instance, in an alternate embodiment, tongue 130 shown in FIG. 13 can alternatively point downward. Likewise, one of ordinary skill in the art would appreciate that the depicted embodiment is interchangeable with other embodiments of separation members, which function to separate a bag being dispensed from a roll of bags from the subsequent bag in the roll of bags.

In still other embodiments, multiple separation members can be present. By way of example, an additional separation member could be placed on first end 106 in an opposite direction from the depicted tongue 130. The additional separation member could be identical to the depicted tongue 130 or could differ.

In operation and with reference to FIGS. 13 and 14, first support member, shown as U-shaped wire 118 and second support member, shown as U-shaped wire 120, are configured to fit within and engage a core 132 of a roll of bags 134. The first biased arm 122 and second biased arm 124 also are each configured to fit within a core 132 of a roll of bags 134. The first biased arm 122 may be biased outwardly (away from first support member 118) such that it must be squeezed inwardly (toward first support member 118) in order to fit within the core of a first roll of bags. After the first biased arm 122 is inserted within the core 132 of a roll of bags 134, it exerts a bias against the core of the first roll of bags and helps secure the roll of bags 134 on dispenser 100. Likewise, first biased arm 122 may provide a braking function that inhibits or reduces the roll of bags from over-spinning and dispensing unwanted bags. The first biased arm 122 may also partially support the roll of bags. The second biased arm 124 acts in the same manner on a separate roll of bags.

In certain embodiments, either the (1) first support member (shown as U-shaped wire 118) and first biased arm 122, or (2) second support member (shown as U-shaped wire 120) and first biased arm 124, may be configured to hold a full roll of bags, and the other may be configured to hold a partial or smaller roll of bags. For instance, in the depicted embodiment in FIGS. 13 and 14, due to the spacing within dispenser 100, U-shaped wire 118 and first biased arm 122 can only hold a partial or smaller roll of bags, and U-shaped wire 120 and second biased arm 124 can hold up to a full or larger roll of bags. In practice, as a roll of bags 134 on U-shaped wire 120 and second biased arm 124 is becoming depleted, such partially depleted roll called a “butt roll,” the butt roll is replaced with a full roll. The butt roll is then loaded onto U-shaped wire 118 and first biased arm 122. The capability of dispenser 100 to hold the butt roll and a full roll renders less likely the premature disposal of the butt roll in favor of a fuller roll. It will be understood to one of ordinary skill in the art that it is within the scope of the present invention for dispenser 100 to be alternatively configured so as to have the capability to hold and dispense two full or larger rolls of bags.

In operation, a consumer may remove a bag from dispenser 100 by pulling a first bag in a roll of bags 134 toward the first end 106. The separation member, depicted as tongue 130, may engage a center slit 62 (shown in FIG. 7). This engagement aids in the tearing of a perforation 60 separating the bag being dispensed from the subsequent hag in the roll. Additionally, first roll of bags 134 can be loaded such that the rolls unwind and dispense bags in either the same or opposite directions.

As consumers pull bags from the roll of bags, the core 132 of the roll of bags 134 may “walk” along the first support member or the second support member, depicted as U-shaped wires 118 and 120, respectively. However, the retainer ends 126 and 128 function to inhibit the roll from “walking” off of the U-shaped wires 118 and 120.

As shown in embodiments depicted in FIGS. 13, 14, and 15, the first biased arm 122 is attached to dispenser 100 only at attachment points D on the side member 110. This configuration permits torsion around the portion of the first biased arm 122 that runs parallel to the side member 110, as shown by the arrow in FIG. 15. This torsion assists in maintaining any desired bias in the first biased arm 122. By contrast, if the first biased arm 122 were attached in an area in close proximity with where the first support member 118 meets the side member 110, any desired bias is likely dissipated more quickly from use due to the torsion not extending across the length of the first biased arm 122 running parallel to the side member 110. For these same reasons, in one embodiment of the present invention, second biased arm 124 may be attached to the side member 110 of dispenser 100 at attachment points E. The attachment of first biased arm 122 and second biased arm 124 can be done by any conventional means, such as welding or bonding.

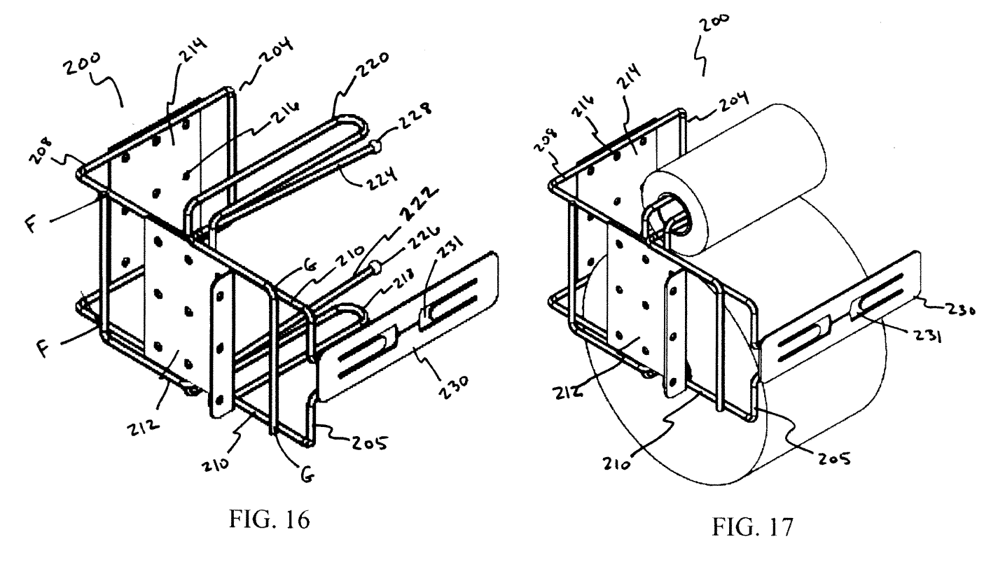

FIG. 16 shows an alternative embodiment in which dispenser 200 comprises a frame 204, which includes a first end 205, a second end 208, and a side member 210. The depicted dispenser 200 also comprises a first mounting plate 212 attached to the side member 210 of frame 204 and a second mounting plate 214 attached to the second end 208 of frame 204. First mounting plate 212 and second mounting plate 214 each have mounting holes 216, which can vary in number and location. The dispenser 200 further includes a first supporting member, shown as U-shaped wire 218, and a first biased member 222 having retainer end 226, and a second supporting member, shown as U-shaped wire 220, and a second biased arm 224 having retainer end 228. The U-shaped wire 220 and second biased arm 224 are attached to side member 210 and are elevated above U-shaped wire 218 and first biased arm 222, which are also attached to the side member 210. In order to permit torsion along the length of the first and second biased arms 222 and 224 as described above, the first biased arm 222 is attached at attachments points F and the second biased arm 224 is attached at attachment points G. The second supporting member 220 and second biased arm 224 can be vertically and horizontally aligned with the first supporting member 218 and first biased member 222, or they alternatively can be misaligned vertically and/or horizontally (e.g., staggered).

The dispenser 200 shown in FIG. 16 also has a separation member, which is depicted as a dispensing plate 230 having a particularly-shaped opening 231. In operation, a consumer pulls a first bag from a roll of bags through the particularly-shaped opening 231 of dispensing plate 230, and the dispensing plate 230 aids in tearing the perforation and separating the bag being dispensed from the subsequent bag in the roll. Although the depicted embodiment shows the separation member as a dispensing plate 230 having a particularly-shaped opening 231, it will be apparent to one of ordinary skill in the art that the present invention encompasses separating members having different shapes. In yet other embodiments, the dispenser 200 can contain multiple separation members of the same or of differing types. For instance, in some embodiments, a single dispensing plate may have multiple open portions such that multiple bags can simultaneously pass through the dispensing plate. In other embodiments, a dispenser may contain multiple dispensing plates. In yet other embodiments, a dispenser may contain both a tongue as a separation member and a dispensing plate as a separation member. In even yet other embodiments, the dispensing plate may have a particularly-shaped opening of a different shape. Thus, one of ordinary skill in the art would appreciate that the separation member encompasses additional embodiments than those expressly set forth in the examples herein.

FIG. 17 shows the dispenser 200 from FIG. 16 with rolls of bags loaded. In this particular embodiment, the first supporting member (shown as U-shaped wire 218) and first biased arm 222 are capable of holding up to a full roll of bags, but the second supporting member (shown as U-shaped wire 220) and second biased arm 224 can only hold a butt roll.

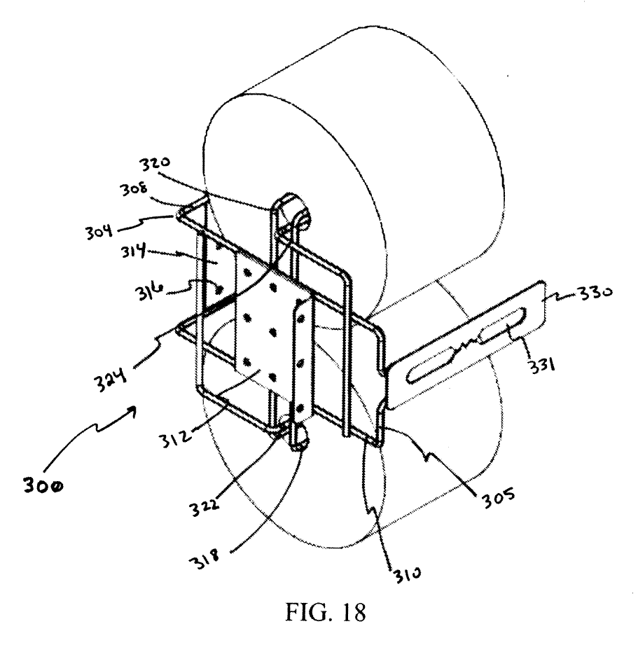

FIG. 18 shows yet another embodiment of the dispenser of the present invention. The dispenser 300 of FIG. 18 differs in two respects from the dispenser 100 shown in FIGS. 16 and 17. First, due to the spacing between (1) the first supporting member (shown as U-shaped wire 318) and the first biased arm 322, and (2) the second supporting member (shown as U-shaped wire 320) and the second biased arm 324, the dispenser 300 of FIG. 18 is capable of holding up to two full, or larger, rolls of bags. Second, the particularly-shaped opening 331 of dispensing plate 330 is of a different shape, which has teeth to aid in the separation of adjacent bags during dispensing.

The embodiments depicted in FIGS. 13-18 show dispensers capable of holding two rolls of bags, but it will be apparent to one of ordinary skill in the art that the present invention encompasses dispensers capable of holding more or less full or partial rolls of bags.

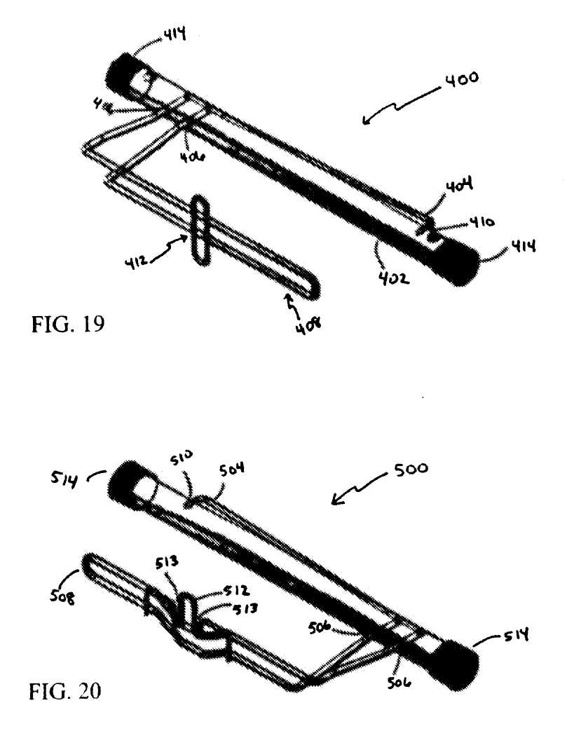

FIG. 19 shows another embodiment of the dispenser of the present invention. In FIG. 19, dispenser 400 has a support member, shown as bar 402, and biased arm 404. Bar 402 has attachment openings 406 in which an extension member, shown as a U-shaped wire 408, is attached. Biased arm 404 may be biased outwardly (away from bar 402), and bar 402 has an opening 410 in which a distal portion of biased arm 404 is retractably positioned. The biased arm 404 is attached to bar 402 at the end opposite the opening 410 by conventional means, such as by welding or bonding. A double tongue 412, which is capable of functioning as two separation members, is attached to U-shaped wire 408. Finally, end caps 414 are optionally placed on the ends of support member 402. In one embodiment, the ends of bar 402 are placed in or attached to a suitable frame (not shown) to support dispenser 400.

In operation, the core of a roll of bags is inserted over the support member, shown as bar 402. In so doing, the biased arm 404 may be pressed inwardly so that its distal end retracts into the opening 410. After the roll of bags is in place on bar 402, the outward bias of the biased arm 404 functions to hold the roll of bags in place and may also serve a braking function as described above. The separation member shown as double tongue 412 functions as otherwise described herein, and the opposing tongues of double tongue 412 allows for the bags to be separated from pulling against either of the tongues. One of ordinary skill in the art will appreciate that alternative embodiments of separation members are within the scope of and interchangeable with the dispenser 400 described herein.

As indicated above, other separation members are within the scope of the present invention. For instance, FIG. 20 shows an alternative embodiment of the present invention as dispenser 500. Dispenser 500 has a tongue 512 with grooves 513 on each side as the separation member. The grooves 513 aid in the separation of adjacent bags during dispensing by “pinching” the bag and thereby aiding in the tear of the perforation separating the adjacent bags.

The present invention also encompasses a bag with a self-opening feature when used with a dispenser having a separation member. In particular, the self-opening bag feature of the present invention functions such that when a single bag is removed from a roll of bags, the subsequent bag is opened (either partially or fully). This self-opening feature allows the next bag in the roll to be removed and used more easily. In contrast to other self-opening bag features in the art, the self-opening feature of the present invention does not require adhesive or corona inducement.

With reference to FIG. 7, the bag of the present invention having a self-opening feature comprises a gusseted bag 50 that is continuously and detachably connected, such as by perforation, to at least one other downstream gusseted bag 51, such as in a roll of bags. The center slit 62 is located in the perforation line 60 between the gussets 58 but the center slit 62 does not extend onto either gusset 58.

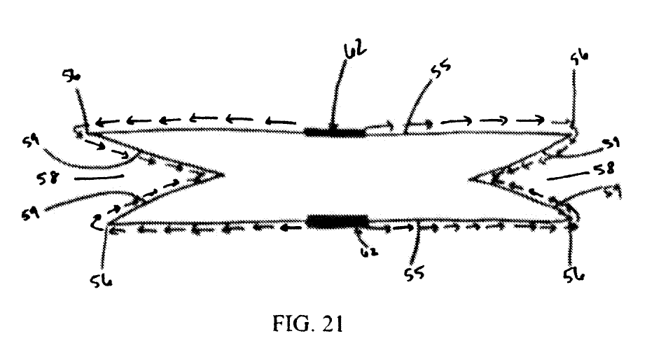

In operation, a user pulls a bag 50 such that the center slit located between the bag 50 being dispensed and the center slit 62 is engaged by a separation member of the dispenser. In this embodiment, the mouth end 54 of bag 50 is dispensed before the bottom end 52. As a result, the outward tearing of the perforation line 60 from the center slit 62 is initiated. As shown in FIG. 21, in which the arrows indicate the sequence of the tearing, the tear pattern of the perforation line first tears the perforation line 60 on each ply of the opposing faces 55 of bag 50 outwardly from the center slit 62 toward the lateral sides 56. Then, as the tear on opposing faces 55 reaches the lateral sides 56 of the bag 50, the tear continues inwardly on the inner gusset folds 59 of gussets 58, i.e., from the lateral side 56 to the inner point of the gusset.

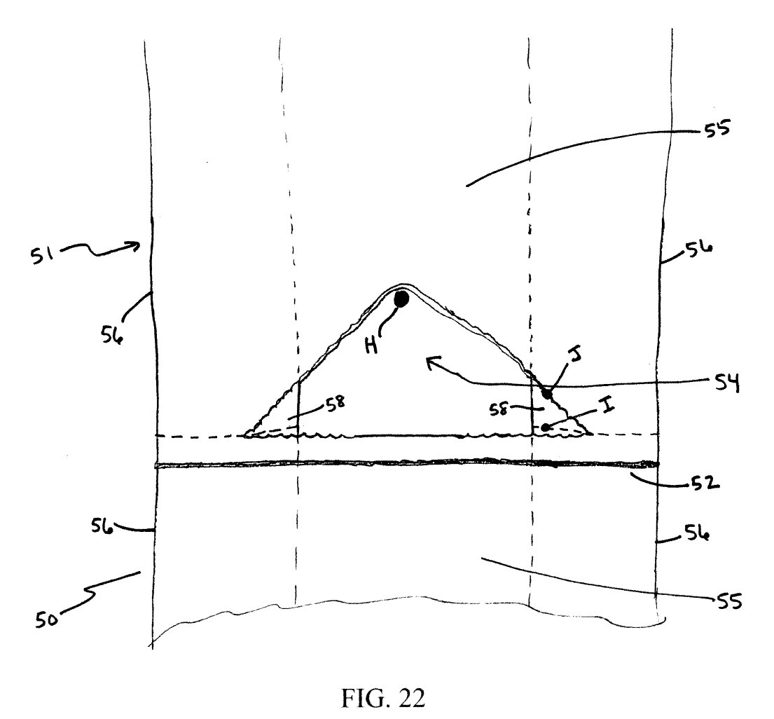

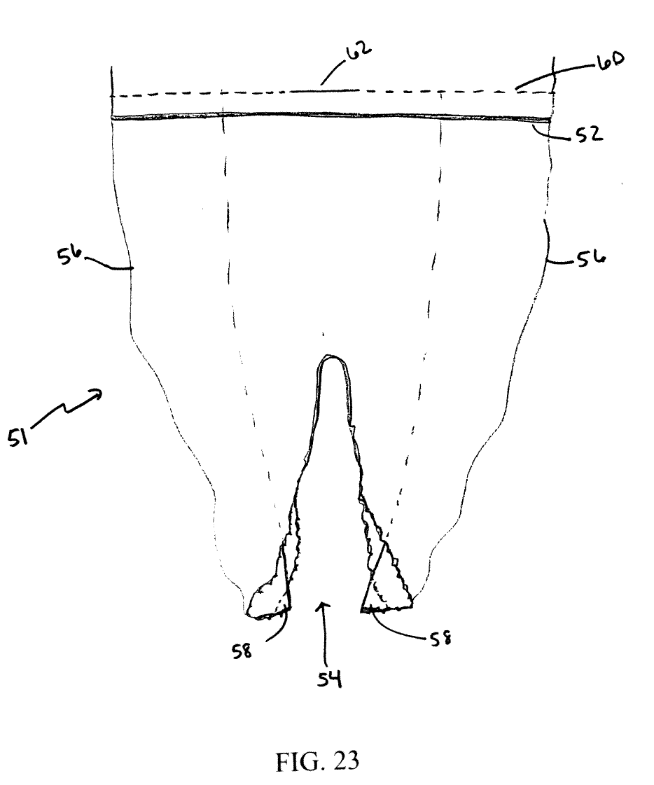

This tear pattern is further shown in FIG. 22, which shows continuous and detachably connected bags 50 and 51 with the perforation line 60 being partially torn on the opposing faces 55 but still untorn on the opposing faces 55 nearest the lateral sides 56 and on the gussets 58. The tearing is aided by a separation member (not shown) located at or around reference point H. As the user continues to pull the bag 50, the perforation line 60 will continue to tear in the pattern shown in FIG. 21. For instance, FIG. 23 depicts bag 51 in isolation at a point during the dispensing process in which the perforation line 60 is completely torn on the opposing faces 55 but is still untorn on the gussets 58. Thus, at the point of dispensing shown in FIG. 23, bag 51 would remain detachably connected to hag 50 (not shown in FIG. 23) by the untorn perforation line 60 on the gussets 58.

As a result of this tearing pattern during dispensing, the gussets 58 of bag 51 are pulled outwardly away from the dispenser by the detachable connection with the gussets 58 of bag 50 until the perforation line 60 is torn in the gussets 58. For instance, as shown in FIG. 22, the perforation line 60 between the gussets 58 on bags 50 and 51 remain detachably connected as the perforation line 60 on opposing faces 55 has begun tearing. As a result of the user's continued pulling on bag 50 during dispensing, the still detachably-connected gussets 58 on bag 51 are pulled outwardly away from the dispenser beyond the tearing opposing faces 55 of bag 51. For instance, as shown in FIG. 22, the still detachably-connected gussets 58, such as at reference point I, are pulled away from the dispenser beyond the already torn portions of perforation line 60 on opposing faces 55, such indicated by reference point J. Similarly, FIG. 23, which shows bag 51 in isolation at a point in the dispensing process in which the perforation line 60 is completely torn on the opposing faces 55 but untorn on the gussets 58, illustrates the untorn gussets 58 of bag 51 (which shown outside of isolation would still be detachably connected to the gussets 58 of bag 50 by the untorn perforation line 60) being pulled outwardly beyond the opposing faces 55 of bag 51.

As a result of using a dispenser with a separation member in conjunction with a continuously and detachably connected gusseted bags comprising a center slit between, but not extending into, the gussets as described above, the dispensing of a bag with the open end dispensed first functions to open the following continuously and detachably connected hag, such as bag 51 in FIG. 22. For instance, as shown in FIG. 23 in isolation, bag 51 has begun to open by the tearing of opposing faces 55. After the gussets tear in the pattern shown in FIG. 21, bag 51 will be at least partially opened. In addition, although the inner folds 59 of the gussets 58 may cling together due to cold welding resulting from the perforation process, those inner folds 59 are separated on bag 51 as the bag 50 is being dispensed due to the continued pulling by the user. In certain prior art embodiments, the perforation line was torn on the opposing faces and the gussets simultaneously, which did not serve to self-open a following continuously and detachably connected bag in a series of bags. This self-opening feature provides convenience to the next user in dispensing and using that following bag that was self-opened.

The foregoing description of illustrative embodiments of the invention has been presented only for the purpose of illustration and description and is not intended to be exhaustive or to limit the invention to the precise forms disclosed. Numerous modifications and adaptations thereof will be apparent to those of ordinary skill in the art without departing from the scope of the present invention.

It will be understood that each of the elements described above, or two or more together, may also find utility in applications differing from the types described. While the invention has been illustrated and described in the general context of consumer bags and relating manufacturing processes and dispensing systems, it is not intended to be limited to the details shown, since various modifications and substitutions can be made without departing in any way from the spirit and scope of the present invention. As such, further modifications and equivalents of the invention herein disclosed may occur to persons skilled in the art using no more than routine experimentation, and all such modifications and equivalents are believed to be within the spirit and scope of the invention as described herein.

What is claimed is:

1. A wound roll of continuous and detachably connected bags, wherein the bags further comprise:
(a) a mouth end;
(b) a bottom end;
(c) two or more opposing faces;
(d) two or more lateral sides;
(e) an arrangement of six plies;
(f) a perforation line detachably connecting the bags;
(g) a gusset on each lateral side; and
(h) a center slit that does not overlap the inner point of the gusset;
wherein the bags are wound in a direction such that a mouth end of each bag is dispensed before a bottom end of the bag.

2. A wound roll of bags of claim 1 wherein the center slit is located between the gussets and does not extend into either gusset.

3. A wound roll of bags of claim 1 wherein the bags further comprise a perforation line.

4. A wound roll of bags of claim 2 in which the tie distance of the perforation line is no more than one half of the adjacent cut distance in the perforation line.

5. A wound roll of bags of claim 1 wherein the center slit is located within the perforation line.

6. A wound roll of bags of claim 1 wherein a slit seal is positioned in the region of the bag having the least plies.

7. A wound roll of bags of claim 1 wherein a slit seal is positioned such that no high spot is formed in the wound roll as a result of the slit seal.

8. A wound roll of bags of claim wherein a first slit seal and a second slit seal are positioned in the region of the bag having the least plies but such that the first slit seal and the second slit seal do not overlap in the wound roll of bags.

9. A wound roll of bags of claim 1 wherein the bags comprise a C-fold.

10. A method for manufacturing a wound roll of continuous and detachably connected bags, said method comprising the steps of:
(a) forming a heat seal in a roll of plastic tubing to form the bottom end of an individual bag;
(b) forming a gusset in the plastic tubing;
(c) perforating the plastic tubing to render adjacent individual bags continuously and detachably connected;
(d) cutting the plastic tubing to form a mouth end for an individual bag;
(e) cutting a center slit in the plastic tubing;
(f) C-folding the plastic tubing at or within the inner gusset point to create six plies; and
(g) winding the bags on a core to dispense in mouth-first direction.

11. A method of claim 10 wherein the center slit is cut between the gussets and does not extend into either gusset.

12. A method of claim 10 in which the bags are perforated such that the tie distance is no more than one half of the adjacent cut distance.

13. A method of claim 10 wherein the center slit is cut within the perforation line.

14. A method of claim 10 wherein the method comprises the additional step of longitudinally cutting and sealing the continuous plastic tubing to create multiple and separate continuous plastic tubings and whereby a slit seal is created.

15. A method of claim 14 wherein the method comprises the additional step of positioning a slit seal such that no high spot is formed in the wound roll as a result of the slit seal.

16. A method of claim 14 comprising the additional step of positioning a first slit seal and a second slit seal in the region of the bag having the least plies but such that the first slit seal and the second slit seal do not overlap in the wound roll of bags.

17. A dispensing system for use with a series of continuously and detachably separable bags wherein the removal of a bag at least partially opens the subsequent bag in the series, the dispensing system comprising:
(a) a dispenser having a separation member;
(b) a series of continuously and detachably separable bags, wherein the bags further comprise:
(i) a mouth end;
(ii) a bottom end;
(iii) two or more opposing faces;
(iv) two or more lateral sides;
(v) an arrangement of six plies;
(vi) a perforation line separating the bags;
(vii) a gusset on each lateral side; and
(viii) a center slit that does not overlap the gusset;
(c) the series of continuously and detachably separable bags wound into a roll such that the mouth end of each bag is dispensed before the bottom end of that bag.

18. The dispensing system of claim 17 wherein the series of continuously and detachably separable bags comprised a C-fold.

19. The dispensing system of claim 17 wherein the series of continuously and detachably separable bags further comprise a slit seal positioned in the region of the bag having the least plies.

20. The dispensing system of claim 17 wherein the series of continuously and detachably separable bags further comprise a slit seal positioned such that no high spot is formed in the wound roll as a result of the slit seal.

21. The dispensing system of claim 17 wherein the series of continuously and detachably separable bags further comprise a first slit seal and a second slit seal positioned in the region of the bags having the least plies but such that the first slit seal and the second slit seal do not overlap in the wound roll of bags.
